(19) United States
(12) Patent Application Publication
(10) Pub. No.: US 2012/0316875 A1
(43) Pub. Date: Dec. 13, 2012

(54) HOSTED SPEECH HANDLING

(75) Inventors: JOEL NYQUIST, Louisville, CO (US); Matthew Robinson, Denver, CO (US)

(73) Assignee: Red Shift Company, LLC, Ridgewood, NJ (US)

(21) Appl. No.: 13/492,398

(22) Filed: Jun. 8, 2012

Related U.S. Application Data
(60) Provisional application No. 61/495,507, filed on Jun. 10, 2011.

(51) Int. Cl. G10L 15/26; G10L 15/00

(52) U.S. Cl. 704/235; 704/231; 704/E15.043; 704/E15.001

(57) ABSTRACT

Embodiments of the invention provide systems and methods for speech signal handling. Speech handling according to one embodiment of the present invention can be performed via a hosted architecture. Electrical signal representing human speech can be analyzed with an Automatic Speech Recognizer (ASR) hosted on a different server from a media server or other server hosting a service utilizing speech input. Neither server need be located at the same location as the user. The spoken sounds can be accepted as input to and handled with a media server which identifies parts of the electrical signal that contain a representation of speech. This architecture can serve any user who has a web-browser and Internet access, either on a PC, PDA, cell phone, tablet, or any other computing device.

### CROSS-REFERENCES TO RELATED APPLICATIONS

The present application claims benefit under 35 USC 119(e) of U.S. Provisional Application No. 61/495,507, filed on Jun. 10, 2011 by Nyquist et al. and entitled “Hosted Speech Handling,” of which the entire disclosure is incorporated herein by reference for all purposes.

### BACKGROUND OF THE INVENTION

Embodiments of the present invention relate generally to methods and systems for speech signal handling and more particularly to methods and systems for providing speech handling in a hosted architecture or as software as a service.

### BRIEF SUMMARY OF THE INVENTION

Embodiments of the invention provide systems and methods for providing speech handling in a hosted architecture or as software as a service. According to one embodiment, processing speech can comprise receiving, at a media server, a stream transmitted from an application executing on a client device. The stream can comprise a packaged signal representing speech. The received signal can be un-packaged by the media server. The media server can then parse the unpackaged received signal into segments containing speech and provide the parsed segments containing speech to a web server.

The web server can receive the parsed segments provided from the media server and perform, e.g., by a speech engine of the web server, a speech-to-text conversion on the received segments. Performing the speech-to-text conversion can comprise generating a text lattice representing one or more spoken sounds determined to be represented in the parsed segments and a confidence score associated with each of the words in the text lattice. The text lattice and associated confidence scores can be returned from the web server to the application executing on the client device. In some cases, the media server can determine a gain control setting based on the received signal. In such cases, the determined gain control setting can be sent from the media server to the application executing on the client device and the determined gain control setting can be used by the application executing on the client device to affect a change in a microphone gain.

The signal received by the media server from the client device can comprise, for example, a continuous stream. In such cases, parsing the received signal can further comprise performing Voice Activity Detection (VAD). Also, in such cases, determining the gain control setting can be based on results of the VAD. In other cases, the received signal can comprise a stream containing only speech-filled audio. That is, the stream can be controlled by the client device to contain only speech-filled audio.

In some implementations, performing the speech-to-text conversion can further comprise determining a meaning or intent for the text of the text lattice. For example, determining the meaning or intent of the text of the text lattice can be based on one or more of a lexical analysis of the text, acoustic features of the received signal, or prosody of the speech represented by the received signal. Additionally or alternatively, determining the meaning or intent of the text of the text lattice can be based on a determined context of the text. In some cases, determining the meaning or intent of the text of the text lattice can be performed by a natural language understanding service. In some implementations, the web server can tag the text lattice with keywords based on the determined meaning or intent of the text in the text lattice. In such cases, the web server can also generate a summary of the keywords tagged to the text lattice and provide the generated summary of keywords tagged to the text lattice to one or more business systems, e.g., in the form a report etc.

According to one embodiment, the application executing on the client device can control a presentation to a user of the client device based on the determined meaning or intent of the text of the text lattice. For example, controlling the presentation to the client device based on the determined meaning or intent of the text of the text lattice can comprise controlling a presentation of a virtual agent. Such a virtual agent may provide a spoken response through the client device. Additionally or alternatively, controlling the presentation to the client device based on the determined meaning or intent of the text of the text lattice comprises generating a request for further information.

### BRIEF DESCRIPTION OF THE DRAWINGS

FIG. 1 is a block diagram illustrating components of an exemplary operating environment in which various embodiments of the present invention may be implemented.

FIG. 2 is a block diagram illustrating an exemplary computer system in which embodiments of the present invention may be implemented.

FIG. 3 is a block diagram illustrating, at a high-level, functional components of a system for processing speech according to one embodiment of the present invention.

FIG. 4 is a flowchart illustrating a process for processing speech according to one embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Embodiments of the invention provide systems and methods for speech signal handling. As will be described in detail below, speech handling according to one embodiment of the present invention can be performed via a hosted architecture. Furthermore, the electrical signal representing human speech can be analyzed with an Automatic Speech Recognizer (ASR) hosted on a different server from a media server or other server hosting a service utilizing speech input. Neither server need be located at the same location as the user. The spoken sounds can be accepted as input to and handled with a media server which identifies parts of the electrical signal that contain a representation of speech. This architecture can serve any user who has a web-browser and Internet access, either on a PC, PDA, cell phone, tablet, or any other computing device. For example, a user can speak a query with a web-page active and the text can be displayed in an input field on the web-page.

According to one embodiment, a speech signal can be transported via the Real Time Messaging Protocol (RTMP) or the Real Time Streaming Protocol (RTSP). The signal can be parsed into one or more speech containing sections and the speech containing sections then sent to an ASR program either on the same server with the media server or otherwise. For example, the one or more speech containing sections can comprise one or more utterances represented in the electrical signal created by the microphone in front of the speaker. According to one embodiment, the one or more speech containing sections can be transported to a hosted Automatic Speech Recognizer. The Automatic Speech Recognizer can convert the received sections and convert each to corresponding text. The text is then sent back to the server or service providing the web-page where is brokered by, for example a Flash Player or a Silverlight Player or any other browser plug-in or client application with microphone access. Various additional details of embodiments of the present invention will be described below with reference to the figures.

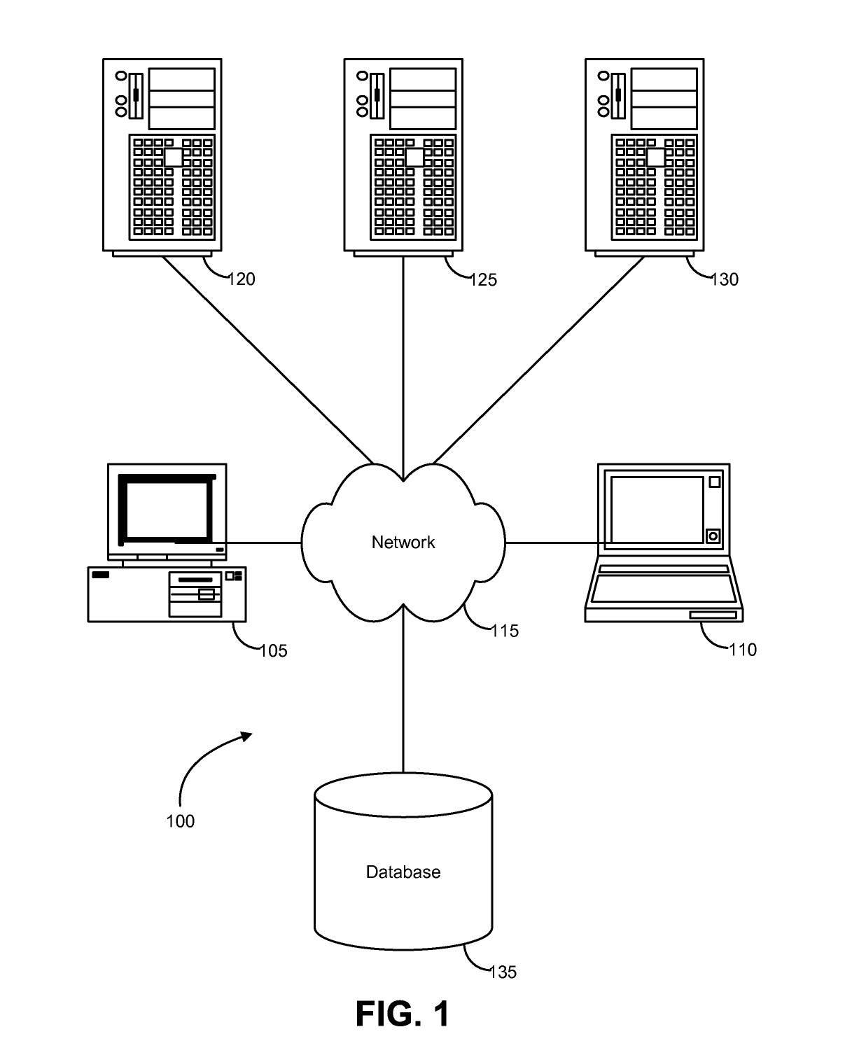

FIG. 1 is a block diagram illustrating components of an exemplary operating environment in which various embodiments of the present invention may be implemented. The system 100 can include one or more user computers 105, 110, which may be used to operate a client, whether a dedicate application, web browser, etc. The user computers 105, 110 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 105, 110 may also have any of a variety of applications, including one or more development systems, database client and/or server applications, and web browser applications. Alternatively, the user computers 105, 110 may be any other electronic device, such as a thin-client computer, Internet-enabled mobile telephone, and/or personal digital assistant, capable of communicating via a network (e.g., the network 115 described below) and/or displaying and navigating web pages or other types of electronic documents. Although the exemplary system 100 is shown with two user computers, any number of user computers may be supported.

In some embodiments, the system 100 may also include a network 115. The network may be any type of network familiar to those skilled in the art that can support data communications using any of a variety of commercially-available protocols, including without limitation TCP/IP, SNA, IPX, AppleTalk, and the like. Merely by way of example, the network 115 may be a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 120, 125, 130 which can be general purpose computers and/or specialized server computers (including, merely by way of example, PC servers, UNIX servers, mid-range servers, mainframe computers rack-mounted servers, etc.). One or more of the servers (e.g., 130) may be dedicated to running applications, such as a business application, a web server, application server, etc. Such servers may be used to process requests from user computers 105, 110. The applications can also include any number of applications for controlling access to resources of the servers 120, 125, 130.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 105, 110. As one example, a server may execute one or more web applications. The web application may be implemented as one or more scripts or programs written in any programming language, such as Java™, C, C# or C++, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 105, 110.

In some embodiments, an application server may create web pages dynamically for displaying on an end-user (client) system. The web pages created by the web application server may be forwarded to a user computer 105 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105, 110, 115, 125, 130. Alternatively, it may be remote from any or all of the computers 105, 110, 115, 125, 130, and/or in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10 g, that is adapted to store, update, and retrieve data in response to SQL-formatted commands.

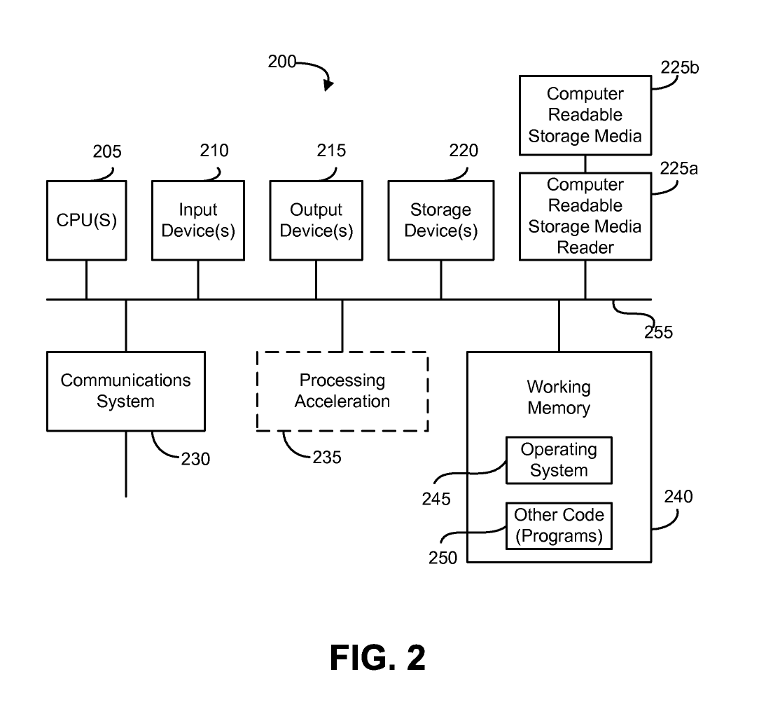

FIG. 2 illustrates an exemplary computer system 200, in which various embodiments of the present invention may be implemented. The system 200 may be used to implement any of the computer systems described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which can include a DSP, a special-purpose processor and/or the like.

The computer-readable storage media reader 225a can further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 220 and/or any other computer described above with respect to the system 200.

The computer system 200 may also comprise software elements, shown as being currently located within a working memory 240, including an operating system 245 and/or other code 250, such as an application program (which may be a client application, web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed. Software of computer system 200 may include code 250 for implementing embodiments of the present invention as described herein.

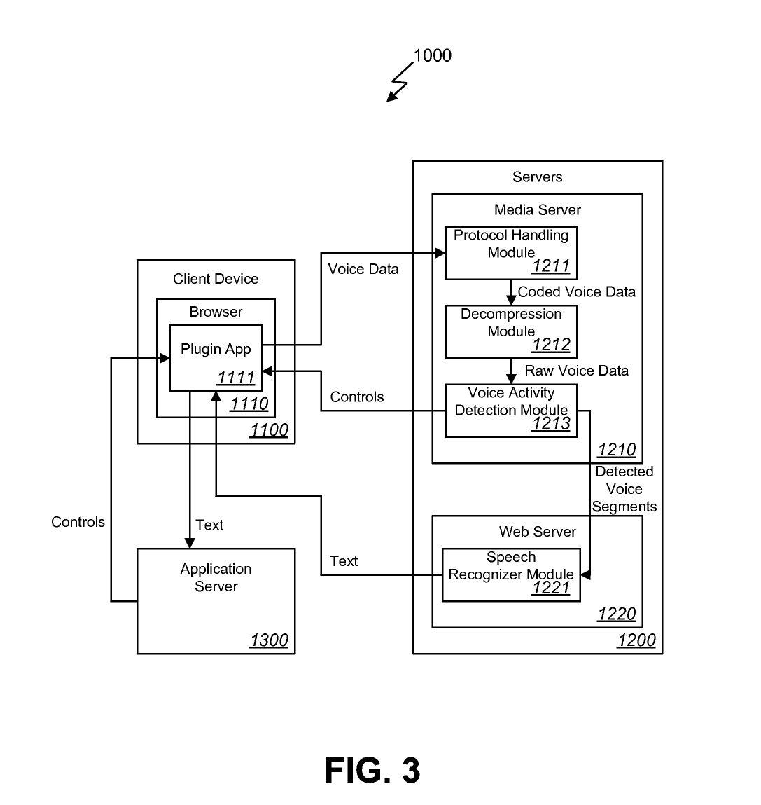

FIG. 3 is a block diagram illustrating components of an exemplary operating environment in which various embodiments of the present invention may be implemented. This example illustrates a topology 1000 as may be built from two computers, the user machine 1100 and the server machine 1200. The user machine 1100 includes a web browser 1110 which in turn contains a plug-in application 1111 that can enable the microphone of user machine 1100. As will be seen, the plug-in application 1111 brokers the transactions. In this example, the server machine includes a media server 1210 and a web server 1220. The media server 1210 in turn contains 3 applications: the first application 1211 can unwrap voice traffic packets (RTMP in this example), the second 1212 can uncompress the unwrapped signal data, while the third 1213 can search through the signal and identify which segments contain speech. The web server 1220 in turn contains a program 1221 that can process speech signals in various ways, e.g. decode into text, identify the existence of keywords/phrases or lack thereof, etc.

Whenever a user initiates a web session he/she is asked permission by the web plug-in application 1111 to use the microphone of the user machine 1100. With microphone access granted, the signal detected by the microphone is wrapped in packets by the plugin application 1111 and sent, for example, via RTP or SIP, to a media server 1210. When more than one user begins a session with their own machine each media stream is uniquely identified and served directly. The media server 1210 can parse the signal such that segments containing speech are identified. Additionally the media server 1210 can send information about the magnitude of the electrical signal back to the plug-in application which in turn can adjust the gain on the microphone. According to one embodiment, the streams of voice data can be analyzed by the speech recognizer module 1221 of the web server 1220 such that the text of the words the user spoke can be hypothesized and returned back to the web plug-in application 1111. According to one embodiment, the plug-in application 1111 can broker the text to a hosted artificial intelligence based language processor 1300 which may produce a different text stream, e.g. an answer to a query, that can in turn be sent back to the plug-in application 1111.

Stated another way, a system 1000 can comprise a client device 1100. The client device 1100 can comprise a processor and a memory communicatively coupled with and readable by the processor. The memory of the client device 1100 can have stored therein a sequence of instruction, i.e., a plug-in or other application 1111, which when executed by the processor, causes the processor to receive a signal representing speech, package the signal representing speech, and transmit the packaged signal.

The system 1000 can further comprise a media server 1210. The media server 1210 can comprise a processor and a memory communicatively coupled with and readable by the processor. The memory of the media server can have stored therein a sequence of instruction which when executed by the processor, causes the processor to receive the packaged signal transmitted from the client device, un-package the received signal, parse the unpackaged received signal into segments containing speech, and provide the segments.

The system 1000 can further comprise a web server 1220 which may or may not be the same physical device as the media server 1210. The web server 1220 can also comprise a processor and a memory communicatively coupled with and readable by the processor. The memory of the web server 1220 can have stored therein a sequence of instruction which when executed by the processor, causes the processor to receive the segments provided from the media server, perform a speech-to-text conversion on the received segments, and return to the client device text from the speech-to-text conversion. The instructions of the memory of the client device can further cause the client device to receive the text from the web server, update an interface of an application of an application server using the received text, and provide to the application server the text through the interface.

According to one embodiment, there is no additional software needed on the user machine. That is, the signal is sent live to the cloud where it can be converted to text and returned to the user's plug-in application. Otherwise, the user would install some software and devote local resources to which may be undesirable to the web site owner and unnecessarily consume local processing resources.

Additionally, great accuracy can be achieved as a result of deploying for constrained domains. That is, rather than using nearly 150,000 word dictionary with statistical language models based on giga-word corpora, the customer application server 1300 may operate within a particular field or area. For example, one such application server 1300 may operate in a medical or insurance field and have a virtual agent designed to answer questions on a specific topic with or utilizing a particular lexicon. Therefore, dictionaries used on the speech recognizer 1221 for a particular customer application server 1300 can be tailored and smaller, e.g., on the order of 1000 words.

So in operation, processing speech can comprise receiving, at a media server 1210, a stream transmitted from an application 1111 executing on a client device 1100. The stream can comprise a packaged signal representing speech. The received signal can be un-packaged by the media server 1210. The media server 1210 can then parse the unpackaged received signal into segments containing speech and provide the parsed segments containing speech to a web server 1220.

The web server 1220 can receive the parsed segments provided from the media server 1210 and perform, e.g., by a speech engine 1221 of the web server 1220, a speech-to-text conversion on the received segments. Performing the speech-to-text conversion can comprise generating a text lattice representing one or more spoken sounds determined to be represented in the parsed segments and a confidence score associated with each of the words in the text lattice. The text lattice and associated confidence scores can be returned from the web server to the application executing on the client device. For example, the text lattice can have time stamps for words the speech engine hypothesizes, e.g., by a Veterbi Algorithm or Hidden Markov Model. The confidence scores can be based on the acoustic model alone or may combine the language probability as well. The acoustic score of each phoneme can come from measuring the likelihood of the hypothesized phoneme model wherever it lands in the space. It is not normalized and can take an appropriate value (e.g. −1e10:1e10) but may vary significantly depending upon the implementation.

In some cases, the media server 1210 can determine a gain control setting based on the received signal. In such cases, the determined gain control setting can be sent from the media server 1210 to the application 1111 executing on the client device 1100 and the determined gain control setting can be used by the application 1111 executing on the client device 1100 to affect a change in a microphone gain. To improve the accuracy of the speech engine, the microphone can be set such to maximize its dynamic range (i.e., multiplying the signal after the fact does not increase the resolution of the sound wave measurements). When a user is speaking (the VAD is collecting audio to be decoded), the root mean square (RMS) of each 200 millisecond frame can be estimated and the gain can be adjusted in an attempt to make the next frame RMS equal to a predetermined value, e.g., 0.10. That is, the gain can be adjusted up if it the RMS is less than the predetermined value and down otherwise. The adjustment can be a direct proportion of the RMS to predetermined value multiplied by a damping coefficient (e.g., 0.3) and checked against a maximum volume turn down to prevent turning below VAD threshold. Stated another way:

newGain=oldGian+oldGain*(1−RMS/0.1)*damp

unless:

(1−RMS/0.1)*damp−cutoff

in which case:

newGain=oldGain−oldGain*cutoff

The cutoff can define how much volume can be adjusted at any one time.

The signal received by the media server 1210 from the client device 1100 can comprise, for example, a continuous stream. In such cases, parsing the received signal can further comprise performing Voice Activity Detection (VAD). Also, in such cases, determining the gain control setting can be based on results of the VAD. In other cases, the received signal can comprise a stream containing only speech-filled audio. That is, the stream can be controlled by the client device 1110 to contain only speech-filled audio.

In some implementations, performing the speech-to-text conversion can further comprise determining by the web server 1220 a meaning or intent for the text of the text lattice. For example, determining the meaning or intent of the text of the text lattice can be based on one or more of a lexical analysis of the text, acoustic features of the received signal, or prosody of the speech represented by the received signal. Additionally or alternatively, determining the meaning or intent of the text of the text lattice can be based on a determined context of the text. In some cases, determining the meaning or intent of the text of the text lattice can be performed by a natural language understanding service (not shown here). In some implementations, the web server 1220 can tag the text lattice with keywords based on the determined meaning or intent of the text in the text lattice. In such cases, the web server 1220 can also generate a summary of the keywords tagged to the text lattice and provide the generated summary of keywords tagged to the text lattice to one or more business systems, e.g., in the form a report etc. Generating reports might tag VIP customers and a lead generation function might tag some text as “users address/phone number” for later contact.

According to one embodiment, the application 1111 executing on the client device 1100 can control a presentation to a user of the client device 1100 based on the determined meaning or intent of the text of the text lattice. For example, controlling the presentation to the client device 1100 based on the determined meaning or intent of the text of the text lattice can comprise controlling a presentation of a virtual agent. Such a virtual agent may provide a spoken response through the client device 1100. Additionally or alternatively, controlling the presentation to the client device 1100 based on the determined meaning or intent of the text of the text lattice comprises generating a request for further information. For example, the user interface presented by the client application 1111 can include avatars that speak back to the user. This interface may include a checkbox or other control that the user can use to whether he is using a headset since using a headset avoids feedback where the avatar tries to understand what it itself is saying. Otherwise, the application 1111 can mute the microphone of the client device 1100 while the avatar speaks and so the user cannot interrupt. However, it should be understood that in other implementations the virtual agent need not play audio or video.

According to one embodiment, the application 1111 executing on the client device 1100 can comprise an Adobe Flash client program, for example written in Action Script and compiled into a Shock Wave Flash movie, that enables audio steaming by coding it into redundant packets and sends them through the Internet. Also this program 1111 can adjust the microphone input gain on the client device 1100 either due to directives from the web server 1200 or mouse clicks on a volume object, etc. The client application 1111 can receive the text back from the speech engine 1221 of the web server 1220 and in the web browser 1110 on the client device 1100 make decisions about what to do with it. For example, the client application 1111 can send the text to a natural language understanding server (not shown here) to get intent, it can display the text, it can send the text to an avatar server (not shown here) or, if they are already rendered, it can simply play a response, etc. That is, the client application 1111 is taking the place of a web server, media server, or other application that would typically manage the dialogue. However, adding this flexibility to the client application allows it to influence or impart some control on the speech engine 1221 of the web server 1220, e.g., if the incoming audio is going to be a 16 digit account number, a date, yes/no, a question about billing etc. Based on such information from the client application 1111 configuration of the speech engine can be changed.

It should be understood that the system 1000 illustrated here can be implemented differently or with many variations without departing from the scope of the present invention. For example, the functions of the media server 1210 and/or the web server 1220 may be implemented “on the cloud” and/or distributed in any of a variety of different ways depending upon the exact implementation. Additionally or alternatively, the functions of the media server 1210 and/or the web server 1220 may be offered as “software as a service” or as “white label” software. Other variations are contemplated and considered to be within the scope of the present invention.

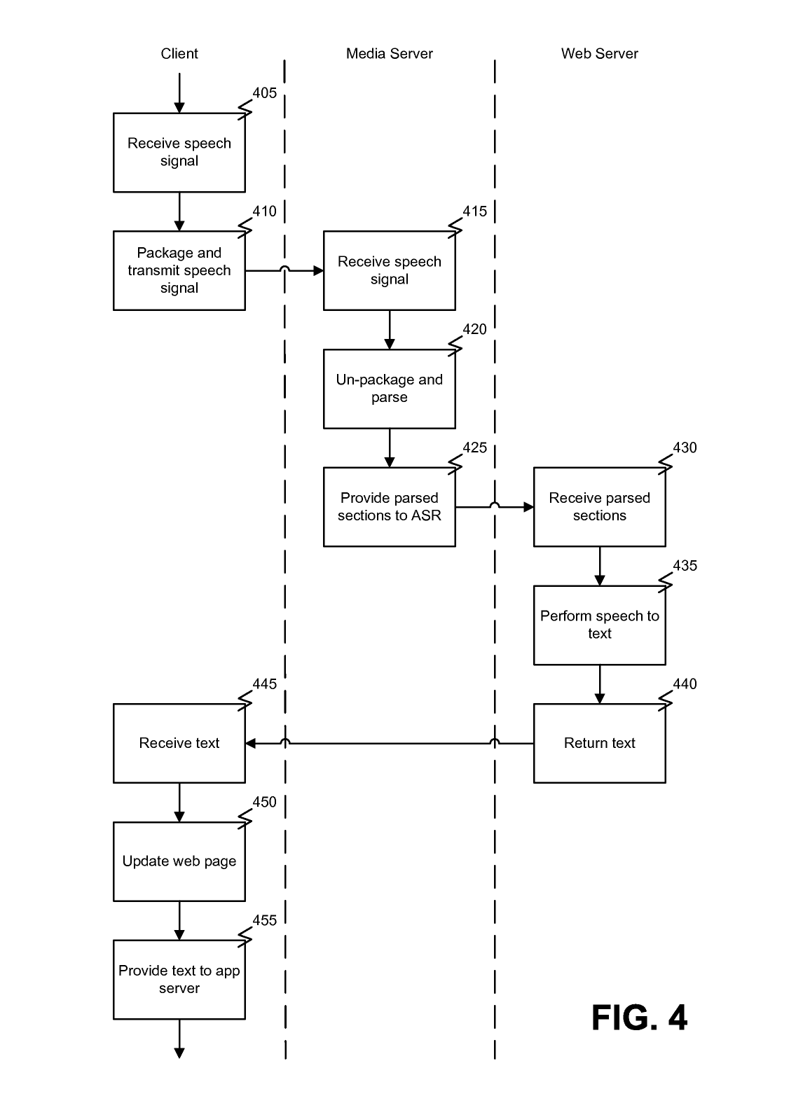

FIG. 4 is a flowchart illustrating a process for processing speech according to one embodiment of the present invention. In this example, the process begins with receiving 405 at a client device a signal representing speech. The client device can package the signal representing speech and transmit 410 the packaged signal.

A media server as described above can receive 415 the packaged signal transmitted from the client device. The media server can un-packaging the received signal and parse 420 the unpackaged received signal into segments containing speech. The parsed segments can then be provided 425 from the media server.

A web server as discussed above can then receive 430 the segments provided from the media server. A speech-to-text conversion can be performing 435 by the web server on the received segments. Text from the speech-to-text conversion can then be returned 440 from the web server to the client device.

The text from the web server can be received 445 at the client device. The client device can update 450 an interface of an application of an application server using the received text and provide 455 the text to the application server through the interface. Therefore, from the perspective of a user of the client device, the user can speak to provide input to an interface provided by the application server such as a web page. The text converted from the received speech by the web server and returned to the client device can then be inserted into input fields of the interface, e.g., into text boxes of the web page, and provided to the application server as input, e.g., to fill a form, to generate a query, to interact with a customer service representative, to participate in a game or social interaction, to update and/or collaborate on a document, etc.

According to one embodiment, a Voice Activity Detection (VAD) may be utilized, for example by the media server. For example, once the microphone is enabled, the media server begins to receive a continuous audio stream while the user is at the web page. Then, the media server can perform VAD on sometimes several minutes of audio that has no voice in it or may include a mix of voice and silence. However, any voice segments should not be split into pieces as that would violate the integrity of the language model. According to one embodiment, the VAD can break the audio stream into frames of predetermined size, e.g., 200 ms frames. The root mean square of the signal for each frame can be uses as an estimate of the energy within that frame.

For example, voice activity can be detected in frames based on Root Mean Squared (RMS) values. In particular, the threshold for which the RMS must be higher than for voice onset to be detected can be a multiplicative factor greater than one times the silence RMS estimate, silRMS. An exemplary multiplicative factor may be 3. After about a second of having the mic open, the standard deviation of the RMS values (silSTD) can be calculated. An initial estimate of silRMS can be the minimum RMS measured during this initialization period.

After the initialization period, the RMS of each successive frame can be evaluated to see if it might be the first frame of a voiced segment by checking to see if the RMS value of the frame is greater than the threshold above described (silThresh). While not in a voiced region, RMS values less than 1e−6 or 2 standard deviations (2*silSTD) below silRMS can be used to tune silRMS and silSTD.

Once a frame triggers VAD, a new threshold (vvThresh), which can be some multiplicative factor less than 1 times the average RMS of voiced frames, can be established. An exemplary factor may be 0.4. From then on, the threshold that the RMS value is checked against can be the maximum of the vvThresh and the silThresh, call this rmsThresh. While in a voiced region, successive frames can be considered voiced while the RMS is greater than half the rmsThresh. The RMS value of each successive frame that is considered voiced can be used to tune vvThresh.

Once the session has been open for more than a few seconds, RMS values can be dropped or discarded from those that are contributing the vvThresh estimate which are not recent. That is, frames older than about 2 seconds are dropped from the estimate of vvThresh.

It should be noted that the process outlined above represents a summary of one exemplary VAD process and additional and/or different steps may be included depending upon the exact implementation. It should also be understood that other methods of performing VAD are contemplated and considered to be within the scope of the present invention.

Additionally or alternatively and according to one embodiment, the ASR Word Accuracy Level can be improved through Automatic Gain Control (AGC). For example, once the session has been open for several seconds the estimate of the background energy and typical voice energy becomes reliable, the client application can adjust the microphone gain. For example, this adjustment can be made locally, by the client application, based on feedback or instruction from the media server, or by a combination thereof.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method of processing speech, the method comprising:
receiving, at a media server, a stream transmitted from an application executing on a client device, the stream comprising a packaged signal representing speech;
un-packaging, by the media server, the received signal;
parsing, by the media server, the unpackaged received signal into segments containing speech; and
providing, from the media server to a web server, the parsed segments containing speech.

2. The method of claim 1, further comprising:
receiving, at the web server, the parsed segments provided from the media server;
performing, by a speech engine of the web server, a speech-to-text conversion on the received segments, wherein performing the speech-to-text conversion comprises generating a text lattice representing one or more spoken sounds determined to be represented in the parsed segments and a confidence score associated with each of the words in the text lattice; and
returning, from the web server to the application executing on the client device, the text lattice and associated confidence scores.

3. The method of claim 1, further comprising:
determining, by the media server, a gain control setting based on the received signal; and
sending, from the media server to the application executing on the client device, the determined gain control setting, wherein the determined gain control setting causes the application executing on the client device to affect a change in a microphone gain.

4. The method of claim 3, wherein the received signal comprises a continuous stream and wherein parsing the received signal further comprises performing Voice Activity Detection (VAD).

5. The method of claim 4, wherein determining the gain control setting is based on results of the VAD.

6. The method of claim 5, wherein determining the gain control setting comprises:
estimating a Root Mean Square (RMS) value of each of a plurality of frames of the signal; and
adjusting the gain to a level where an estimated RMS value of a next frame of the signal after the plurality of frames is at a predetermined value, wherein said adjusting is in direct proportion of the estimated RMS value of the plurality of frames to the predetermined value multiplied by a damping coefficient and within a maximum cutoff value.

7. The method of claim 3, wherein the received signal comprises a stream containing only speech-filled audio.

8. The method of claim 7, wherein the stream is controlled by the client device to contain only speech-filled audio.

9. The method of claim 2, wherein performing the speech-to-text conversion further comprises determining a meaning or intent for the text of the text lattice.

10. The method of claim 9, further comprising changing a configuration of the speech engine of the web server by the application executing on the client.

11. The method of claim 9, wherein determining the meaning or intent of the text of the text lattice is based on one or more of a lexical analysis of the text, acoustic features of the received signal, or prosody of the speech represented by the received signal.

12. The method of claim 9, wherein determining the meaning or intent of the text of the text lattice is based on a determined context of the text.

13. The method of claim 9, wherein determining the meaning or intent of the text of the text lattice is performed by a natural language understanding service.

14. The method of claim 2, further comprising tagging, by the web server, the text lattice with keywords based on the text in the text lattice.

15. The method of claim 14, further comprising:
generating, by the media server, a summary of the keywords tagged to the text lattice; and
providing, from the media server to one or more business systems, the generated summary of keywords tagged to the text lattice.

16. The method of claim 9, further comprising controlling, with the application executing on the client device, a presentation to a user of the client device based on the determined meaning or intent of the text of the text lattice.

17. The method of claim 16, wherein controlling the presentation to the client device based on the determined meaning or intent of the text of the text lattice comprises controlling a presentation of a virtual agent, the virtual agent providing a spoken response through the client device.

18. The method of claim 16, wherein controlling the presentation to the client device based on the determined meaning or intent of the text of the text lattice comprises generating a request for further information.

19. A system comprising:
a client device executing a client application, the client application generating and sending a stream, the stream comprising a packaged signal representing detected speech of a user of the client device;
a media server communicatively coupled with the client device, the media server receiving the stream transmitted from the client application executing on a client device, un-packaging the received signal, and parsing the unpackaged received signal into segments containing speech; and
a web server communicatively coupled with the media server, wherein the media server provides the parsed segments containing speech to the web server and wherein the web server receives the parsed segments provided from the media server, performs a speech-to-text conversion on the received segments, wherein performing the speech-to-text conversion comprises generating a text lattice representing one or more spoken sounds determined to be represented in the parsed segments and a confidence score associated with each of the words in the text lattice, and returns the text lattice and associated confidence scores to the application executing on the client device.

20. The system of claim 19, wherein the media server further determines a gain control setting based on the received signal and sends the determined gain control setting and wherein the client application on the client device receives the determined gain control setting from the media server and affects a change in a microphone gain based on the determined gain control setting.

21. The system of claim 20, wherein the signal from the client device comprises a continuous stream and wherein parsing the received signal further comprises performing Voice Activity Detection (VAD).

22. The system of claim 21, wherein determining the gain control setting is based on results of the VAD.

23. The system of claim 20, wherein the received signal from the client device comprises a stream containing only speech-filled audio.

24. The system of claim 23, wherein the stream from the client device is controlled by the client application to contain only speech-filled audio.

25. The system of claim 19, wherein performing the speech-to-text conversion further comprises determining a meaning or intent for the text of the text lattice.

26. The system of claim 25, wherein the client application changes a configuration of the speech engine of the web server.

27. The system of claim 25, wherein determining the meaning or intent of the text of the text lattice is based on one or more of a lexical analysis of the text, acoustic features of the received signal, or prosody of the speech represented by the received signal.

28. The system of claim 25, wherein determining the meaning or intent of the text of the text lattice is based on a determined context of the text.

29. The system of claim 25, wherein determining the meaning or intent of the text of the text lattice is performed by a natural language understanding service.

30. The system of claim 25, wherein the web server further tags the text lattice with keywords based on the determined meaning or intent of the text in the text lattice.

31. The system of claim 30, wherein the media server further generates a summary of the keywords tagged to the text lattice and provides to one or more business systems the generated summary of keywords tagged to the text lattice.

32. The system of claim 25, wherein the client application of the client device further controls a presentation to a user of the client device based on the determined meaning or intent of the text of the text lattice.

33. The system of claim 32, wherein controlling the presentation to the client device based on the determined meaning or intent of the text of the text lattice comprises controlling a presentation of a virtual agent, the virtual agent providing a spoken response through the client device.

34. The system of claim 32, wherein controlling the presentation to the client device based on the determined meaning or intent of the text of the text lattice comprises generating a request for further information.
